(19) United States
(12) Patent Application Publication
(10) Pub. No.: US 2016/0210608 A1
(43) Pub. Date: Jul. 21, 2016

(54) MERCHANT INTERFACE FOR TRANSACTION-RELATED SERVICES

(71) Applicant: MasterCard International Incorporated, Purchase, NY (US)

(72) Inventors: Robert D. Reany, New Canaan, CT (US); Steve Hubbard, Leicester (GB); Dennis A. Gamiello, Yorktown Heights, NY (US); Janet Marie Smith, Ballwin, MO (US); Gregory D. Williamson, Stamford, CT (US)

(21) Appl. No.: 14/983,080

(22) Filed: Dec. 29, 2015

Related U.S. Application Data
(60) Provisional application No. 62/105,543, filed on Jan. 20, 2015.

(51) Int. Cl. G06Q 20/22; G06Q 20/36

(52) U.S. Cl. CPC G06Q 20/227; G06Q 20/36

(57) ABSTRACT

A method includes receiving, from a merchant, transaction data and supplemental data relating to a payment account transaction. The method further includes accessing at least one service selection rule. Also, based on the at least one service selection rule and the transaction data and supplemental data, at least one service is selected. The selected service(s) are provided to the merchant in connection with the payment account transaction.

### CROSS REFERENCE TO RELATED APPLICATION

This application claims the benefit of U.S. Provisional Patent Application No. 62/105,543 filed on Jan. 20, 2015, the contents of which are hereby incorporated by reference for all purposes.

### BACKGROUND

Many consumer purchases are now made over the Internet. It is often the case that such transactions (sometimes referred to as “e-commerce transactions”) involve payment accounts as the means of payment.

FIG. 1 is a block diagram that illustrates a conventional payment system 100 as it may be utilized in an e-commerce transaction.

The system 100 includes a customer device 102 such as a personal computer or a smartphone that runs a mobile web browser. Block 104 in FIG. 1 represents a merchant e-commerce server that may host an e-commerce website that the customer accesses via his/her device 102. The merchant e-commerce server 104 may also be considered part of the payment system 100.

In a typical transaction on an e-commerce website, the customer may select one or more items of merchandise displayed on pages in the website. The customer may then elect to “check-out”. As part of the check-out process, the customer may enter an address to which the merchandise is to be shipped. In addition, the customer may enter payment account data, including for example a payment account number, expiration date and security code, as well as the customer's name as it appears on the payment account.

A computer 106 operated by an acquirer (acquiring financial institution) is also shown as part of the system 100 in FIG. 1. The acquirer computer 106 may receive a payment account system authorization request message for the transaction from the merchant e-commerce server 104. The acquirer computer 106 may route the authorization request message via a payment network 108 to a server computer 110 operated by the issuer of a payment account that is associated with the account number entered by the customer and included in the authorization request message. The authorization response message generated by the payment issuer server computer 110 may be routed back to the merchant e-commerce server 104 via the payment network 108 and the acquirer computer 106.

One well known example of a payment network is referred to as the “Banknet” system, and is operated by MasterCard International Incorporated, which is the assignee hereof

The payment account issuer server computer 110 may be operated by or on behalf of a financial institution (“FI”) that issues payment accounts to individual users such as the customer referred to above. For example, the payment card issuer server computer 110 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their e-commerce servers. The system may also include a very large number of payment account holders, who engage in e-commerce transactions. It will also be understood that the payment system 100 may include additional components, such as point of sale terminals, by which purchase transactions may be handled in brick-and-mortar retail stores.

In connection with some e-commerce transactions, the merchant may find it to be necessary or desirable to receive assistive services in addition to the services provided to the merchant by the merchant's acquirer in connection with the flow of authorization request and response messages and subsequent clearing of transactions. Payment service providers exist that provide such assistive services to merchants.

One example of such a service is a wallet selector service. A wallet selector service may be invoked when, during the online purchase transaction process, the customer selects an option provided by the merchant e-commerce server 104 to allow the customer to access one of the user's digital wallets to aid the user in selecting—from a digital wallet—a payment account that the customer wishes to use for the current online purchase transaction. MasterCard International Incorporated, the assignee hereof, currently provides wallet selector services to merchants under the service mark, “MasterPass”.

A user authentication service is another assistive service that may be provided to the merchant in connection with an online transaction. “SecureCode” is an example of a user authentication service that is currently available (from MasterCard International Incorporated) and in use in connection with online purchase transactions. When the SecureCode service is invoked in connection with an online purchase transaction, the account issuer may challenge the customer to provide a PIN or a response to a security question to serve as a “something-you-know” form of user authentication for the customer.

The present inventors have recognized that there are opportunities to improve and simplify the manner in which merchants functionally integrate their computer systems with payment service providers in connection with implementing assistive services. Moreover, the present inventors have recognized opportunities for providing additional flexibility and convenience for merchants in requesting assistive services.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram representation of a conventional payment system.

FIG. 2 is a block diagram representation of portions of a payment system provided in accordance with aspects of the present invention.

FIG. 3 is a block diagram representation of a computer system that may be provided in accordance with aspects of the present invention and that may be part of the payment system partially illustrated in FIG. 2.

FIG. 3A is a block diagram representation of another computer system that may be provided in accordance with aspects of the present invention and that may be part of the payment system partially illustrated in FIG. 2.

FIG. 4 is a flow chart that illustrates a process that may be performed in the system of FIG. 2 in accordance with aspects of the present invention.

### DETAILED DESCRIPTION

In general, and for the purpose of introducing concepts of embodiments of the present invention, a single data communication interface may be provided between a merchant and a payment service provider to allow the merchant to selectively access a number of different assistive services provided by the payment service provider to the merchant in connection with “card not present” transactions. Thus, a merchant may be able to access a number of different assistive services via a single functional integration of the merchant's computer systems with those of the payment service provider. Moreover, the payment service provider computer that serves the merchant may store service selection rules for the merchant, so that one or more services to be provided for a given transaction may be automatically selected for a given transaction based on criteria and/or strategies defined by the merchant.

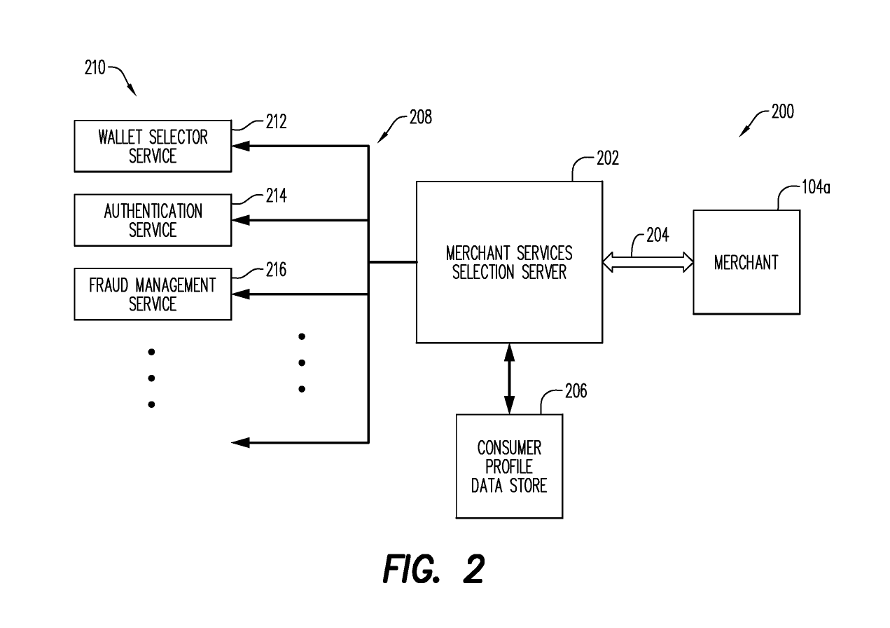

FIG. 2 is a block diagram representation of portions of a payment system 200 provided in accordance with aspects of the present invention.

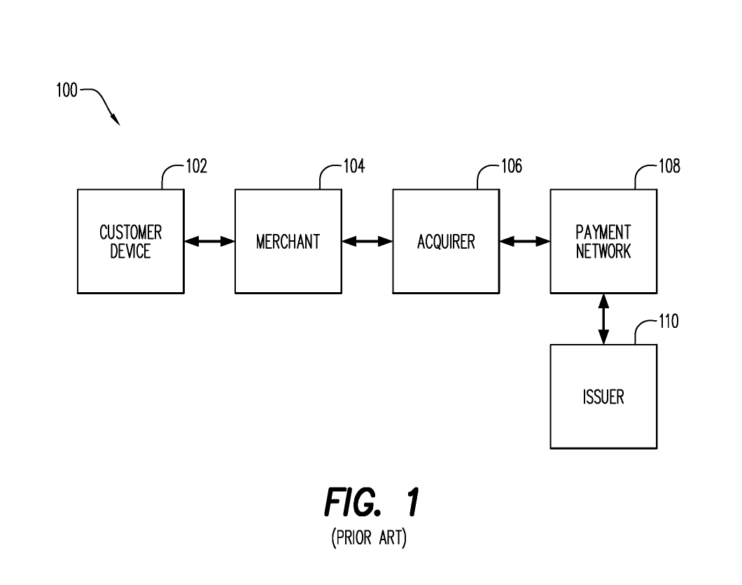

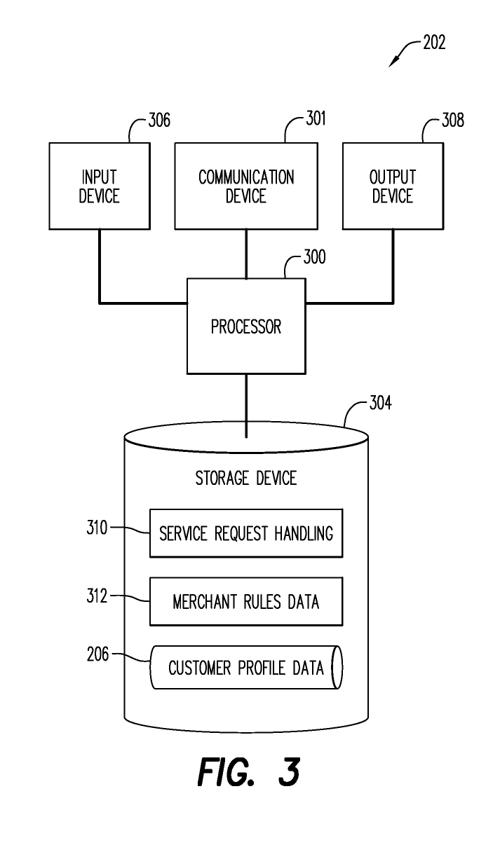

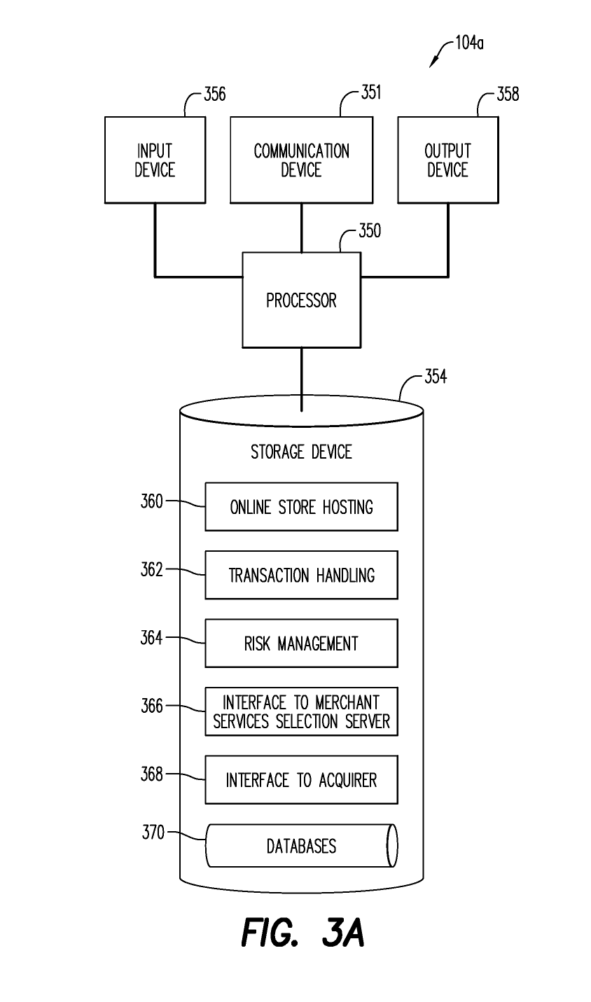

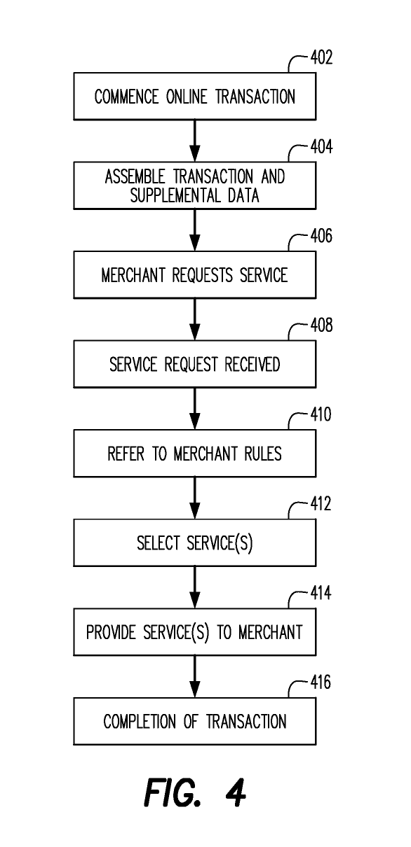

The payment system 200 may include a merchant services selection server 202. Details of the merchant services selection server 202 will be provided below, including the upcoming discussion of FIGS. 3 and 4. The merchant services selection server 202 may be operated by a payment service provider (not separately shown). The payment service provider may, in some cases, be a part of, or may be associated with, the operator of a payment network such as the payment network 108 shown in FIG. 1.

The payment system 200 may also include a merchant e-commerce server 104a. The merchant e-commerce server 104a may include much or all of the functionality of the merchant e-commerce server 104 referred to above in connection with FIG. 1. In addition, the merchant e-commerce server 104a may interact with the merchant services selection server 202 via an interface 204 so as to function in accordance with aspects of the present invention.

In some embodiments, the interface 204 between the merchant e-commerce server 104a and the merchant services selection server 202 may be implemented in a form such as a two-way API (application programming interface). The data exchange over the interface 204 may be secured by suitable data communication security measures. There will be discussion below concerning types of data that the merchant e-commerce server 104a may provide via the interface 204 to the merchant services selection server 202.

As discussed in further detail below, a consumer profile data store 206 may be associated with and accessible by the merchant services selection server 202.

As schematically illustrated at 208, in connection with a given transaction the merchant services selection server 202 may selectively invoke one or more of a number of different assistive services 210 that may be provided to the merchant in connection with the transaction. The assistive services 210 may include a wallet selector service 212, a user authentication service 214 and a fraud management service 216. The assistive services 210 that are selectable by the merchant services selection server 202 may in addition or alternatively include other or additional assistive services of types currently available or as introduced in accordance with future developments. For any particular type of assistive service, the merchant services selection server 202 may selectively provide access to one or more different service offerings. Thus, for example, the merchant services selection server 202 may selectively provide access to one or more types of authentication services, including user and/or device authentication services. Examples of authentication services accessible via the merchant services selection server 202 may include “SecureCode” (as mentioned above) and 3DS (three domain secure) services and/or similar service offerings currently available or available in the future and/or other types of assistive services that may become available in the future. By the same token, the merchant services selection server 202 may provide access to more than one different type of fraud management service. Examples of fraud management services may include services such as transaction and device ID fraud risk scoring.

In some embodiments, any one or more of the types of service offerings discussed above may be omitted from the assistive services 210 accessible via the merchant services selection server 202.

In some embodiments, computing resources that perform one or more of the assistive services may be associated with and/or at least partially integrated with the merchant services selection server 202.

The payment system 200 of FIG. 2 may include additional components which are not shown in that drawing, including for example payment system components such as those described above in connection with FIG. 1. Thus, for example, the payment system 200 may also include numerous instances of acquirer computers, account issuer server computers, and customer devices. Further, the payment system 200 may include at least one payment network.

Moreover, the components of the system 200 as depicted in FIG. 2 are only those that are needed for processing a single transaction, or transactions for a single merchant. A typical payment system may process many purchase transactions (including simultaneous transactions) and requests for assistive services and may include computer systems operated by numerous e-commerce merchants. Each e-commerce merchant may have a respective interface to the merchant services selection server 202.

FIG. 3 is a block diagram that illustrates an example embodiment of the merchant services selection server 202 as shown in FIG. 2 and provided in accordance with aspects of the present invention.

Referring now to FIG. 3, the merchant services selection server 202 may be constituted by commercially available computer hardware in terms of its hardware aspects but may be controlled by software to cause it to function as described herein. For example, the merchant services selection server 202 may be constituted by commercially available server computer hardware.

The merchant services selection server 202 may include a computer processor 300 operatively coupled to a communication device 301, a storage device 304, an input device 306 and an output device 308. The computer processor 300 may be in communication with the communication device 301, the storage device 304, the input device 306 and the output device 308.

The computer processor 300 may be constituted by one or more processors. Processor 300 operates to execute processor-executable steps, contained in program instructions described below, so as to control the merchant services selection server 202 to provide desired functionality.

Communication device 301 may be used to facilitate communication with, for example, other devices (such as a number of computers operated by e-commerce merchants, and computers that provide assistive services to merchants). For example, communication device 301 may comprise numerous communication ports (not separately shown), to allow the merchant services selection server 202 to communicate simultaneously with a number of other computers and other devices, including communications as required to simultaneously handle numerous service requests.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the merchant services selection server 202, executed by the processor 300 to cause the merchant services selection server 202 to function as described herein.

The programs may include one or more conventional operating systems (not shown) that control the processor 300 so as to manage and coordinate activities and sharing of resources in the merchant services selection server 202, and to serve as a host for application programs (described below) that run on the merchant services selection server 202.

The programs stored in the storage device 304 may also include a service request handling application program 310 that controls the processor 300 to enable the merchant services selection server 202 to handle requests for services from the merchant e-commerce server 104a in a manner described below.

The storage device 304 may also store, and the merchant services selection server 202 may also execute, other programs, which are not shown. For example, such programs may include a reporting application, which may respond to requests from system administrators for reports on the activities performed by the merchant services selection server 202. The other programs may also include, e.g., one or more data communication programs, database management programs, device drivers, etc.

The storage device 304 may also store a database 312 of rules that may govern the selection by the merchant services selection server 202 of services to be provided in connection with particular requests for service. For example, the rules database 312 may store rules defined or selected by various merchants to implement criteria and/or strategies the merchants wish the merchant services selection server 202 to apply in connection with the service requests made by the merchants. Thus, for each merchant, the rules database 312 may store one or more rules to be applied to the service requests submitted to the merchant services selection server 202 by the respective merchant. Operation of such rules will be described below in connection with FIG. 4.

In addition, and continuing to refer to FIG. 3, the storage device 304 may store the customer profile data 206 referred to above in connection with FIG. 2. In some embodiments, data partitions for particular customers/payment account holders may be built over time by the merchant services selection server 202 based on service requests received from merchants with respect to the customers. In some embodiments, the customer profile data store 206 may provide insights into customer habits and transaction patterns that may be of value in assessing risks related to future transactions and/or in applying rules stored in the rules database 312. In some embodiments, customers may be identified only by account numbers/payment tokens reported by merchants in their service requests. In other embodiments, the merchant services selection server 202 may have sufficient identifying information about individual customers to provide a unified profile for at least some customers across some or all of various account numbers and/or payment tokens associated with the customers. In some embodiments, the profile for a given customer may include one or more risk scores that have been generated with respect to the customer. Such profiles may be stored in the data store 206.

The storage device 304 may also store one or more additional databases (not separately shown) required for operation of the merchant services selection server 202.

Like the merchant services selection server 202, the merchant e-commerce server 104a may be constituted by commercially available computer hardware, and may have the same types of hardware architecture and hardware aspects as described above in connection with the description of the merchant services selection server 202.

FIG. 3A is a block diagram that illustrates an example embodiment of the merchant e-commerce server 104a as shown in FIG. 2 and provided in accordance with aspects of the present invention.

The merchant e-commerce server 104a may be controlled by software to cause it to function as described herein.

The merchant e-commerce server 104a may include a computer processor 350 operatively coupled to a communication device 351, a storage device 354, an input device 356 and an output device 358. The components of the merchant e-commerce server 104a, as recited in the preceding sentence, may, in some embodiments, have similar characteristics and interrelationships as like-named components of the merchant services selection server 202 as described above.

The computer processor 350 may be constituted by one or more processors. Processor 350 operates to execute processor-executable steps, contained in program instructions described below, so as to control the merchant e-commerce server 104a to provide desired functionality.

Storage device 354 stores one or more programs for controlling processor 350. The programs comprise program instructions (which may be referred to as computer readable program code means) that contain processor-executable process steps of the merchant e-commerce server 104a, executed by the processor 350 to cause the merchant e-commerce server 104a to function as described herein.

The programs may include one or more conventional operating systems (not shown) that control the processor 350 so as to manage and coordinate activities and sharing of resources in the merchant e-commerce server 104a, and to serve as a host for application programs (described below) that run on the merchant e-commerce server 104a.

The programs stored in the storage device 354 may also include an application program 360 that controls the processor 350 to enable the merchant e-commerce server 104a to host an online store/e-commerce shopping website. Further, the storage device 354 may store an application program 362 for handling purchase transactions requested by visitors to the merchant's online store. In some embodiments, the transaction handling application program 362 may cause the merchant e-commerce server 104a to interact with the merchant services selection server 202 to obtain assistive services as described herein.

Still further, the storage device 354 may store a risk management application program 364. The risk management program application program 364 may, with respect to at least some transactions, assess to what extent the transactions present risk, and may cooperate with the transaction handling application program 362 in determining requests and/or inputs to be provided from the merchant e-commerce server 104a to the merchant services selection server 202.

In addition, the storage device 354 may store a software interface 366 which enables and/or supports software integrations between the merchant e-commerce server 104a and the merchant services selection server 202.

Moreover, the storage device 354 may store a software interface 368 to support interconnectivity between the merchant e-commerce server 104a and the merchant's acquirer (such as block 106 described above in connection with FIG. 1).

Continuing to refer to FIG. 3A, the storage device 354 may also store, and the merchant e-commerce server 104a may also execute, other programs, which are not shown. For example, such programs may include a reporting application, which may respond to requests from system administrators for reports on the activities performed by the merchant e-commerce server 104a. The other programs may also include, e.g., one or more data communication programs, database management programs, device drivers, etc.

The storage device 354 may also store one or more databases 370. The databases 370 may store, for example, a database of transaction histories relating to the merchant's online and/or in-store customers.

FIG. 4 is a flow chart that illustrates a process that may be performed in the payment system 200 of FIG. 2 in accordance with aspects of the present invention.

At 402 in FIG. 4, an online purchase transaction may be commenced. As will be appreciated in view of previous discussion herein, this may include a customer using a customer device (PC or browser-enabled mobile device) to access an e-commerce website hosted by the merchant e-commerce server 104a. Initial stages of the online purchase transaction may also include the customer viewing and selecting merchandise, and opting to trigger a check-out procedure.

Processing at block 404 in FIG. 4 may follow and/or overlap with the processing at block 402. At block 404, the merchant e-commerce server 104a may receive and/or assemble data related to the current online purchase transaction. This may include, for example, transaction data of the kind typically needed to build a payment account transaction authorization request. This transaction data may include, for example, a payment account number or payment token, the customer's name, account expiration date, account security code, transaction amount, date and time of transaction, merchant identifying data, transaction type data (e.g., an indication that this is an online transaction), etc.

In addition, the merchant e-commerce server 104a may assemble supplemental information that is not necessarily included in a payment account transaction authorization request. For example, the supplemental data may include data relating to the device by which the customer accessed the e-commerce website. The device data may be relatively simple (e.g., just an identification of the operating system employed by the device) or may range in complexity up to and including a rather complete device fingerprint or profile. In some embodiments, the device data may be of a kind required to implement services in which mobile payment applications are enabled to be used for remote/online transactions. In some embodiments, the device data may include the device's current location, a history of transactions performed using the device and/or a risk score that has been assigned to the device by the merchant and/or the merchant's acquirer. In some embodiments, the device data may include a device identifier and/or a mobile telephone number associated with the device. As is familiar to those who are skilled in the art, a device fingerprint and/or a device profile may be or may include information collected about a remote computing device for the purpose of identification of the device. A device fingerprint and/or a device profile may be used to fully or partially identify individual users or devices, and this may aid in the identification of genuine cardholders versus perpetrators of fraud.

In some embodiments, the supplemental data may include one or more risk scores, transaction history, etc., related to the customer but not necessarily related to the customer device. In some embodiments, the supplemental data may include an indication that the customer has selected a particular option in interacting with the check-out process. For example, the supplemental data may indicate that the customer has selected an option to use a digital wallet associated with the customer in selecting a payment account to be used for the current transaction.

At block 406 in FIG. 4, the merchant e-commerce server 104a may transmit a service request to the merchant services selection server 202 via the interface 204. In some embodiments, the merchant e-commerce server 104a may perform this function in connection with every online purchase transaction that it handles. In other embodiments, the merchant e-commerce server 104a may only perform this function with respect to some but not all of the online purchase transactions that it handles. For example, the merchant e-commerce server 104a may perform this function in response to one or more triggering circumstances. The triggering circumstances may include the customer's selection of an option to use a digital wallet; and/or the level of a risk score assigned to the customer, the customer device and/or the transaction; and/or the amount of the transaction; and/or the type or types of merchandise purchased; and/or an over-all assessment of risk related to the transaction.

In some embodiments, the service request at 406 may include the merchant e-commerce server 104a transmitting to the merchant services selection server 202 via the interface 204 some or all of the transaction data and/or supplemental data assembled by the merchant e-commerce server 104a at block 404.

In some embodiments, and/or in some cases, the request for service at 406 may be conditional in that it is a possible outcome of the operation of the balance of the process of FIG. 4 that the merchant services selection server 202 may determine that no access to assistive services is warranted for the current transaction in view of the data provided by the merchant e-commerce server 104a as considered in view of one or more applicable rules.

At 408 in FIG. 4, the merchant services selection server 202 may receive the service request (and associated transaction and/or supplemental data) transmitted at 406.

At 410 in FIG. 4, the merchant services selection server 202 may access the rules data (in the rules database 312, FIG. 3) applicable to the merchant to access one or more rules that may be applicable to the current transaction. In some cases the rule or rules may be relatively simple. For example, if the supplemental data indicates that the customer has requested wallet selection, then the rule may provide that the merchant services selection server 202 is to invoke the wallet selector service 212 (FIG. 2). In another example of a rule that may be accessed at 410, a rule may indicate which, if any, authentication service is to be provided, based on data relating to the transaction amount, device history and customer risk score, as indicated by data contained in the service request. In still another example of a rule that may be accessed at 410, a rule may indicate that one or more risk management/evaluation services are to be provided to the merchant for the current transaction. Again, transaction amount, device history, and/or risk score and/or other types of data may be used as inputs to such a rule.

Many other permutations and/or parameters may be implemented with respect to rules that may be stored in the database 312 and accessed at block 410.

At 412, the merchant services selection server 202 may select one or more assistive services to be provided to the merchant in connection with the current transaction in accordance with indications provided by application of the rule or rules accessed at 410.

At 414, the services selected at 412 may be provided to the merchant. The invoking of the selected services may, in some embodiments, be via one or more MPIs (merchant plug-ins). In some embodiments, some or all of the selected services may be provided to the merchant by the operator of the merchant services selection server 202 (e.g., the payment network operator). In some embodiments, some or all of the services may be provided to the merchant by third party service providers invoked by the merchant services selection server 202 in response to selection of one or more services at 412.

At 416, the transaction may be completed. This may involve the outcome of provision of the services selected by the merchant services selection server 202 at 412 and provided at 414. This may also involve the merchant e-commerce server 104a generating an authorization request message as typically occurs in connection with online purchase transactions, routing of the authorization request message to the account issuer, generation of an authorization response message by the issuer and routing of the authorization response message to the merchant e-commerce server 104a, all as described above in connection with FIG. 1. This may also involve fulfillment and shipment of the purchased merchandise by the merchant, and charging of the transaction to the customer's payment account that the customer selected for the transaction.

With an arrangement as illustrated in FIGS. 2-4, the merchant's computer system may be functionally integrated with a number of different assistive services via a single interface. This may provide significant advantages and economies to the merchant, as compared to existing arrangements in which the merchant may separately integrate its computer system to each desired assistive service.

Further, with the merchant services selection server 202 engaging in rules-based selection of services, transaction-by-transaction, this may allow merchants to implement payment strategies, risk strategies and economic decisions, so that the merchant can receive assistive services in a manner and under circumstances so as to achieve the trade-offs it desires relative to risk, cost, security, customer convenience and experience, and likelihood of approval of transactions by the account issuer.

Another advantage of the arrangement of FIGS. 2-4 is that the payment service provider (e.g., a payment network operator) may conveniently package together a number of service offerings for merchants in a manner that may make it attractive to the merchant to adopt the entire package of service offerings. The arrangement of FIGS. 2-4 may also facilitate the introduction and/or updating of new or additional service offerings to merchants via the existing interface shown in FIG. 2. If the service provider also provides services to account issuers, the arrangement of FIGS. 2-4 may aid the service provider in implementing merchant-facing services that are also of value to account issuers.

An example of a merchant-facing service that is also of value to an account issuer may be device fingerprinting and/or device profiling. Account issuers may desire to receive services that provide the issuers with visibility as to whether a transaction is associated with a good (reliable) device fingerprint/device profile or one that has been associated with fraud to aid in issuers' decision making.

Still further, by having all assistive services for the transaction invoked via the merchant services selection server 202, the transaction flow may be more seamless, more secure, and more customer-friendly.

Although the above example transactions have been described in connection with an online purchase transaction, the teachings of this disclosure are also applicable to other types of “card not present” transactions.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment account” includes a credit card account, a deposit account that the account holder may access using a debit card, a prepaid card account, or any other type of account from which payment transactions may be consummated. The terms “payment account” and “payment card account” are used interchangeably herein. The term “payment account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving, in a computer, from a merchant, transaction data and supplemental data relating to a payment account transaction;
accessing, by the computer, at least one service selection rule;
based on the at least one service selection rule and the received transaction data and supplemental data, selecting at least one service; and
providing the selected at least one service to the merchant in connection with the payment account transaction.

2. The method of claim 1, wherein the supplemental data includes device data concerning a device that was used to access the merchant's website in connection with the payment account transaction.

3. The method of claim 2, wherein the device data includes at least one of (a) an identification of an operating system running on the device; (b) a mobile telephone number associated with the device; (c) a device identifier; (d) a device fingerprint; (e) a device profile; and (f) a risk score assigned to the device.

4. The method of claim 1, wherein the supplemental data includes at least one of (a) a risk score; and (b) a transaction history, said transaction history relating to past transactions engaged in by a customer who initiated the payment account transaction.

5. The method of claim 1, wherein the supplemental data includes an indication that the payment account transaction included selection of a digital wallet option.

6. The method of claim 1, wherein the selection of the at least one service is based in part on a customer profile stored in the computer and relating to an individual who initiated the payment account transaction.

7. The method of claim 1, wherein the at least one service includes at least one of (a) a wallet selector service; (b) a user authentication service; (c) a device authentication service; and (d) a fraud management service.

8. An apparatus comprising:
a processor; and
a memory in communication with the processor, the memory storing program instructions, the processor operative with the program instructions to perform functions as follows:
receiving, from a merchant, transaction data and supplemental data relating to a payment account transaction;
accessing at least one service selection rule;
based on the at least one service selection rule and the received transaction data and supplemental data, selecting at least one service; and
providing the selected at least one service to the merchant in connection with the payment account transaction.

9. The apparatus of claim 8, wherein the supplemental data includes device data concerning a device that was used to access the merchant's website in connection with the payment account transaction.

10. The apparatus of claim 9, wherein the device data includes at least one of (a) an identification of an operating system running on the device; (b) a mobile telephone number associated with the device; (c) a device identifier; (d) a device fingerprint; (e) a device profile; and (f) a risk score assigned to the device.

11. The apparatus of claim 8, wherein the supplemental data includes at least one of (a) a risk score; and (b) a transaction history, said transaction history relating to past transactions engaged in by a customer who initiated the payment account transaction.

12. The apparatus of claim 8, wherein the supplemental data includes an indication that the payment account transaction included selection of a digital wallet option.

13. The apparatus of claim 8, wherein the selection of the at least one service is based in part on a customer profile stored in the computer and relating to an individual who initiated the payment account transaction.

14. The apparatus of claim 8, wherein the at least one service includes at least one of (a) a wallet selector service; (b) a user authentication service; (c) a device authentication service; and (d) a fraud management service.

15. A non-transitory storage medium storing program instructions, the program instructions including:
instructions for receiving, in a computer, from a merchant, transaction data and supplemental data relating to a payment account transaction;
instructions for accessing, by the computer, at least one service selection rule;
instructions for selecting at least one service based on the at least one service selection rule and the received transaction data and supplemental data; and
instructions for providing the selected at least one service to the merchant in connection with the payment account transaction.

16. The storage medium of claim 15, wherein the supplemental data includes device data concerning a device that was used to access the merchant's website in connection with the payment account transaction.

17. The storage medium of claim 16, wherein the device data includes at least one of (a) an identification of an operating system running on the device; (b) a mobile telephone number associated with the device; (c) a device identifier; (d) a device fingerprint; (e) a device profile; and (f) a risk score assigned to the device.

18. The storage medium of claim 15, wherein the supplemental data includes at least one of (a) a risk score; and (b) a transaction history, said transaction history relating to past transactions engaged in by a customer who initiated the payment account transaction.

19. The storage medium of claim 15, wherein the supplemental data includes an indication that the payment account transaction included selection of a digital wallet option.

20. The storage medium of claim 15, wherein the at least one service includes at least one of (a) a wallet selector service; (b) a user authentication service; (c) a device authentication service; and (d) a fraud management service.
